(19) United States
(12) Patent Application Publication
(10) Pub. No.: US 2024/0037907 A1
(43) Pub. Date: Feb. 1, 2024

(54) Systems and Methods for Image-Based Augmentation of Scanning Operations

(71) Applicant: ZEBRA TECHNOLOGIES CORPORATION, Lincolnshire, IL (US)

(72) Inventors: David S. Koch, East Islip, NY (US); Miroslav Trajkovic, Setauket, NY (US); Yan Zhang, Buffalo Grove, IL (US); Sam Leitch, Waterdown (CA); Dimitry Kapmar, Lincolnshire, IL (US)

(21) Appl. No.: 17/874,384

(22) Filed: Jul. 27, 2022

(51) Int. Cl. G06V 10/764; G06V 10/44; G06V 10/22; G06V 10/774; G06V 10/74; G06V 10/147; G06K 7/14; G06K 7/10

(52) U.S. Cl. CPC G06V 10/764; G06V 10/44; G06V 10/225; G06V 10/774; G06V 10/74; G06V 10/147; G06K 7/1413; G06K 7/10722; G06V 2201/07

(57) ABSTRACT

A method includes: responsive to a scan command, controlling a sensor assembly to scan a machine-readable indicium within a sensor field of view; obtaining an image corresponding to the sensor field of view; determining, from the machine-readable indicium, a decoded item identifier and a scan confidence level associated with the decoded item identifier; determining, from the image, a classified item identifier corresponding to the machine-readable indicium, and a classification confidence level associated with the classified item identifier; selecting, based on the scan confidence level and the classification confidence level, one of the decoded item identifier and the classified item identifier; and generating output data based on the selected one of the decoded item identifier and the classified item identifier.

### BACKGROUND

In facilities housing item-handling operations, e.g., retail facilities with inventory receiving, shelf stocking, and the like, item identifiers encoded in barcodes affixed to items can be used to track item-handling operations and detect status information (e.g., misplaced items). Image recognition processes may be employed in such facilities to augment or replace barcode scanning. However, such facilities may contain large and variable sets of distinct items, which may impede the effectiveness of image recognition processes.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a facility.

FIG. 2 is a flowchart of a method for image-based augmentation of scanning operations.

FIG. 3 is a diagram illustrating an example performance of block 215 of the method of FIG. 2.

FIG. 4 is a diagram illustrating an example performance of block 220 of the method of FIG. 2.

FIG. 5 is a diagram illustrating an example performance of block 235 of the method of FIG. 2.

FIG. 6 is a flowchart of a method for image-based item status monitoring.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: responsive to a scan command, controlling a sensor assembly to scan a machine-readable indicium within a sensor field of view; obtaining an image corresponding to the sensor field of view; determining, from the machine-readable indicium, a decoded item identifier and a scan confidence level associated with the decoded item identifier; determining, from the image, a classified item identifier corresponding to the machine-readable indicium, and a classification confidence level associated with the classified item identifier; selecting, based on the scan confidence level and the classification confidence level, one of the decoded item identifier and the classified item identifier; and generating output data based on the selected one of the decoded item identifier and the classified item identifier.

Additional examples disclosed herein are directed to a computing device, comprising: a sensor assembly; and a processor configured to: responsive to a scan command, control the sensor assembly to scan a machine-readable indicium within a sensor field of view; obtain an image corresponding to the sensor field of view; determine, from the machine-readable indicium, a decoded item identifier and a scan confidence level associated with the decoded item identifier; determine, from the image, a classified item identifier corresponding to the machine-readable indicium, and a classification confidence level associated with the classified item identifier; select, based on the scan confidence level and the classification confidence level, one of the decoded item identifier and the classified item identifier; and generate output data based on the selected one of the decoded item identifier and the classified item identifier.

Further examples disclosed herein are directed to a method, comprising: responsive to a scan command, controlling a sensor assembly to scan a machine-readable indicium within a sensor field of view; obtaining an image corresponding to the sensor field of view; determining, from the machine-readable indicium, a decoded item identifier; determining, from the image, a classified item identifier corresponding to the machine-readable indicium, and a classification confidence level associated with the classified item identifier; selecting, based on the classification confidence level, one of the decoded item identifier and the classified item identifier; and generating output data based on the selected one of the decoded item identifier and the classified item identifier.

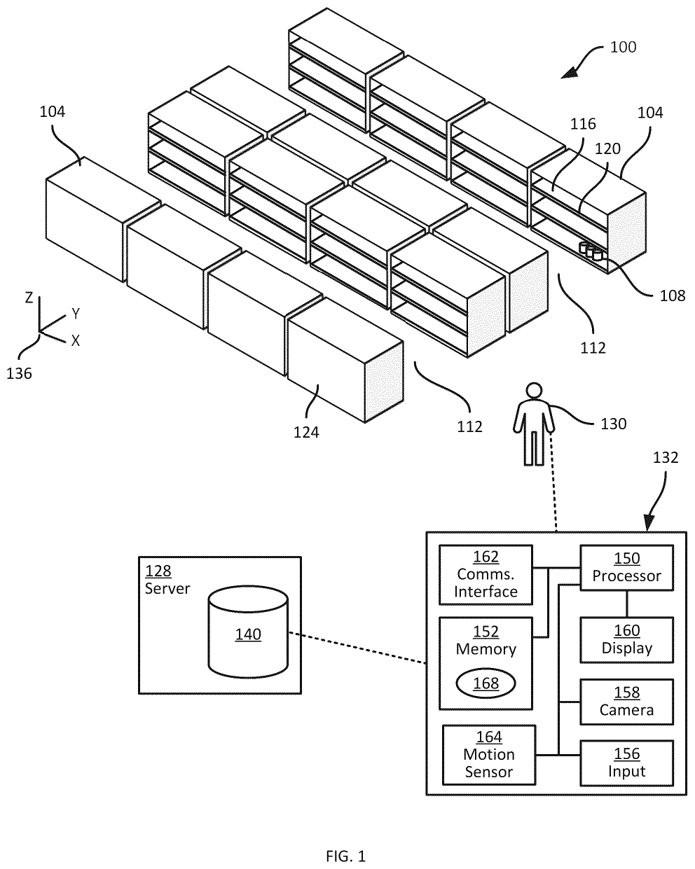

FIG. 1 illustrates an interior of a facility, such as a retail facility (e.g., a grocer). In other examples, the facility 100 can be a warehouse, a healthcare facility, a manufacturing facility, or the like. The facility 100 includes a plurality of support structures 104, such as shelf modules, carrying items 108. In the illustrated example, the support structures 104 are arranged in sets forming aisles 112. FIG. 1, specifically, illustrates two aisles 112 each formed by eight support structures 104. The facility 100 can have a wide variety of layouts other than the example layout shown in FIG. 1.

The support structures 104 include support surfaces 116, such as shelves, pegboards, and the like, to support the items 108 thereon. The support surfaces 116, in some examples, terminate in shelf edges 120, which face into the corresponding aisle 112. A shelf edge 120, as will be apparent to those skilled in the art, is a surface bounded by adjacent surfaces having different angles of inclination. In the example illustrated in FIG. 1, each shelf edge 120 is at an angle of about ninety degrees relative to the corresponding support surface 116 above that shelf edge 120 and the underside (not shown) of the support surface 116. In other examples, the angles between a shelf edge 120 and adjacent surfaces is more or less than ninety degrees.

The support surfaces 116 carry the items 108, which can include products for retrieval by customers, workers, and the like in the facility. As seen in FIG. 1, the support surfaces 116 are accessible from the aisle 112 into which the shelf edges 120 face. In some examples, each support structure 104 has a back wall 124 rendering the support surfaces 116 inaccessible from the side of the support structure 104 opposite the shelf edges 120. In other examples, however, the support structure 104 can be open from both sides (e.g., the back wall 124 can be omitted).

As will be apparent, the facility 100 may contain a wide variety of items 108 disposed on the support structures 104. For instance, a retail facility such as a grocer may contain tens of thousands of distinct products, and numerous instances of each product (e.g., arranged into adjacent facings on a shelf). Managing the inventory of items in the facility 100 includes the performance of a variety of workflows, implemented by staff and/or automated systems within the facility 100, to detect or generate status information corresponding to the items. For example, upon receipt of items, e.g., in pallets, boxes, or the like, staff may dismantle the pallets and/or unpack boxes, and confirm that the expected items have been received by comparing the items received against a delivery manifest or other order record. Such a comparison is generally made by scanning barcodes affixed to each item, encoding product identifiers (e.g., universal product codes (UPCs) or the like). In further examples, restocking shelves includes, upon placing an item on a shelf, scanning a barcode affixed to the item to document the updated inventory level of that item type on the shelf. In still further examples, stock check or planogram compliance workflows include scanning barcodes affixed to items on the shelves, and comparing the product identifiers so obtained with a database, map, or the like, specifying which item(s) are expected at the relevant locations.

In other words, the above-mentioned workflows—other examples of which will also occur to those skilled in the art—may involve a significant number of scanning operations, e.g., to capture and decode a machine readable indicium such as a one- or two-dimensional barcode affixed to each item. Each scan operation may involve an operator input to a mobile computing device, as well as a period of time to perform the computations necessary to capture, detect, and decode a barcode, and communicate with other computing devices (such as a server storing the above-mentioned database).

In some systems, the detection of item status information such as low stock, plugs (i.e., items 108 that are misplaced), compliance with delivery manifests, and the like, can be at least partially automated via the use of image recognition systems. For example, some facilities include cameras configured to collect images of the support structures 104 and the items 108 thereon. The cameras can be fixed cameras deployed in the facility 100, and/or cameras disposed on mobile devices deployed within the facility 100, carried by staff in the facility 100, and the like. The captured images can then be processed, e.g., at a server 128, to detect individual items 108 therein and determine item status information.

The detection of items 108 within images as mentioned above can be implemented according to various recognition mechanisms, such as machine-learning based classifiers. Examples of such classifiers include You Only Look Once (YOLO), neural networks such as Mask R-CNN (a region-based convolutional neural network). Image-based item recognition may enable the detection of numerous items from a single image, and may therefore reduce the number and/or frequency of barcode scan operations involved in performing at least some of the above-mentioned inventory management operations.

The appearance of the items 108, however, may change periodically, albeit unpredictably and potentially without warning to the operator of the facility 100. For example, package form factors, graphics on packaging, and the like, may be altered by the manufacturers of the items 108, without changes to the item identifiers encoded in the previously mentioned barcodes. Thus, while the potentially more time consuming scanning operations may a remain reliable mechanism for completing inventory management workflows, processes based on recognition of the items 108 from images may be rendered ineffective by visual changes to the items, until classifiers are retrained. The facility 100 therefore includes, as will be discussed below in greater detail, certain components and functionality to enable the adaptation of image recognition-based processes to changes in appearance of items 108. The functionality implemented by those components also enables the continued use, to at least a certain degree, of image recognition processes even prior to retraining or other adaptations to altered item appearances.

In particular, a worker 130 in the facility can be equipped with a mobile computing device 132, also referred to simply as a device 132. The device 132 can be a tablet computer, a smart phone, a wearable computer (e.g., smart glasses), or the like. In some examples, the device 132 can be implemented as distinct devices, e.g., with distinct physical housings, connected via a wired or wireless communications link. The device 132 implements functionality to assist the worker 130 in completing various tasks in the facility 100, in association with the previously mentioned inventory management workflows. An example task includes a pick task, in which the worker 130 retrieves specific items 108 from support structures, e.g., to fill an online order received from a customer of the facility 100. Various other tasks will also occur to those skilled in the art, including planogram compliance verification, restocking, delivery unpacking, and the like.

The functionality implemented by the device 132 in connection with a pick task can include receiving (e.g., from the server 128) a list of item identifiers to be picked, and/or presenting directional guidance to the worker 130 indicating locations of such items in the facility 100. When a given item 108 is picked from a support structure 104 according to guidance provided by the device 132, the worker 130 may control the device 132 to scan a barcode associated with the picked item 108. The barcode may appear on a label associated with the item 108, e.g., affixed to a shelf edge 120. Scanning of the barcode can provide confirmation that the item 108 has been picked, and thereby enable the device 132 to track progress of the pick task.

As will be apparent, therefore, the device 132 travels throughout the facility 100 while tasks such as picking are performed. In other examples, the device 132 can be implemented as part of a mobile apparatus that is autonomous or semi-autonomous, rather than as a portable device carried by the worker 130 as noted above. Further, the device 132 includes components enabling the capture of images. The device 132 is configured to capture and process images, e.g., during the performance of other tasks by the worker 130. Processing of such images enables the device 132 to perform additional tasks beyond the primary pick task, and/or to partially automate the primary task by reducing the number of barcode scans involved in completing the primary task. As will be discussed below, the device 132 can employ the results of barcode scans, together with the results of processing captured images, to identify items 108 that have not been explicitly scanned for barcodes, detect visual changes in the items 108, and the like.

The device 132 can be configured to track its pose (i.e., position and orientation) within the facility 100, e.g., according to a previously established coordinate system 136. The tracked pose of the device 132 can, in some examples, be employed to determine locations (also within the coordinate system 136) of items 108 identified within images captured by the device 132. Such location information can be used to report status information, such as misplaced items 108 and the like.

The server 128 can store a repository 140, such as a planogram or realogram, specifying locations of each item type 108 in the facility 100, item identifiers such as a UPC or other identifier for each item type, pricing information, stock levels (e.g., a number of instances of a given item type at a particular location in the facility 100), and the like.

Certain internal components of the device 132 are illustrated in FIG. 1. In particular, the device 132 includes a special-purpose controller, such as a processor 150, interconnected with a non-transitory computer readable storage medium, such as a memory 152. The memory 152 includes a combination of volatile memory (e.g., Random Access Memory or RAM) and non-volatile memory (e.g., read only memory or ROM, Electrically Erasable Programmable Read Only Memory or EEPROM, flash memory). The processor 150 and the memory 152 each comprise one or more integrated circuits.

The device 132 also includes at least one input device 156 interconnected with the processor 150. The input device 156 is configured to receive input and provide data representative of the received input to the processor 150. The input device 156 includes any one of, or a suitable combination of, a touch screen, a keypad, a trigger button, a microphone, and the like. In addition, the device 132 includes a sensor assembly for capturing images and machine readable indicia such as barcodes. In this example, the sensor assembly includes a camera 158 including a suitable image sensor or combination of image sensors. The camera 158 is controllable by the processor 150 to capture images (e.g., single frames or video streams including sequences of image frames). The camera 158 can include either or both of a two-dimensional camera, and a three-dimensional camera such as a stereo camera assembly, a time-of-flight camera, or the like. In other words, the camera 158 can be enabled to capture either or both of color data (e.g., values for a set of color channels) and depth data.

Barcode scans can be implemented by the camera 158 by, for example, extracting a portion of an image captured by the camera, for processing via a suitable barcode detection and decoding process. In other examples, the above-mentioned sensor assembly can include a barcode scanner distinct from the camera 158, such as another image sensor, a laser-based scanner, or the like. In some examples, the barcode scanner can be implemented in a distinct housing, e.g., as a ring-based scanner worn on the hand of the worker 130.

The device 132 also includes a display 160 (e.g., a flat-panel display integrated with the above-mentioned touch screen) interconnected with the processor 150, and configured to render data under the control of the processor 150. The client device 132 can also include one or more output devices in addition to the display 160, such as a speaker, a notification LED, and the like (not shown).

The device 132 also includes a communications interface 162 interconnected with the processor 150. The communications interface 162 includes any suitable hardware (e.g., transmitters, receivers, network interface controllers and the like) allowing the client device 132 to communicate with other computing devices via wired and/or wireless links (e.g., over local or wide-area networks). The specific components of the communications interface 162 are selected based on the type(s) of network(s) or other links that the device 132 is required to communicate over.

Further, the device 132 can include a motion sensor 164, such as an inertial measurement unit (IMU) including one or more accelerometers, one or more gyroscopes, and/or one or more magnetometers. The motion sensor 164 is configured to generate data indicating detected movement of the device 132 and provide the data to the processor 150, for example to enable the processor 150 to perform the pose tracking mentioned earlier.

The memory 152 stores computer readable instructions for execution by the processor 150. In particular, in the illustrated example the memory 152 stores an application 168 which, when executed by the processor 150, configures the processor 150 to perform various functions discussed below in greater detail and related to the capture of images of items 108 and augmentation of barcode-based operations via processing of such images. The application 168 may also be implemented as a suite of distinct applications in other examples. Those skilled in the art will appreciate that the functionality implemented by the processor 150 via the execution of the application 168 may also be implemented by one or more specially designed hardware and firmware components, such as FPGAs, ASICs and the like in other embodiments.

As will be apparent, the memory 152 can also store various other applications, such as picking application or the like, enabling the device 132 to provide directional and/or task guidance to the worker 130. Such other applications can be executed simultaneously with the application 168.

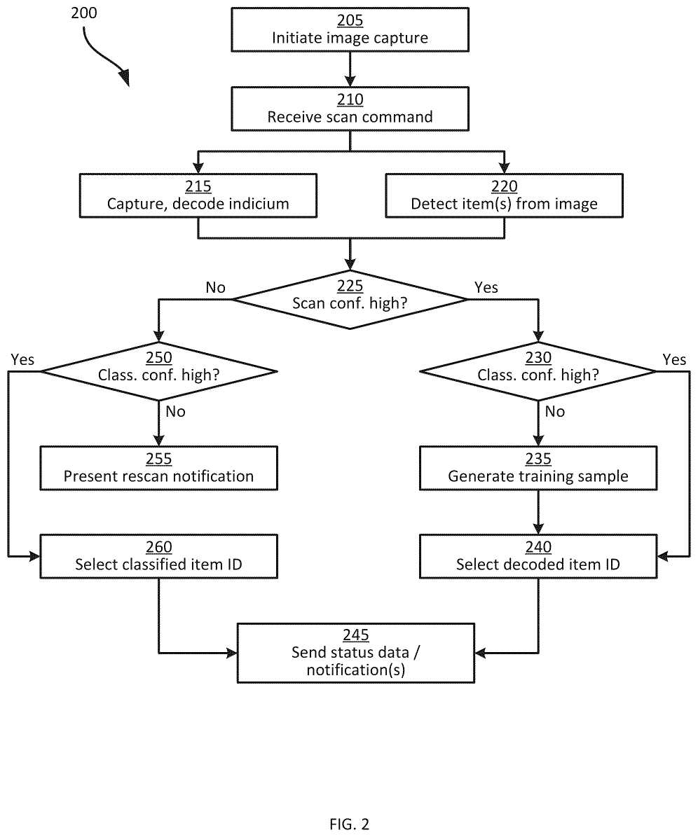

Turning to FIG. 2, a method 200 of image-based augmentation of scanning operations is shown. The method 200 will be described in conjunction with its performance in the facility 100, specifically by the device 132. In some examples, as will be apparent in the discussion below, the server 128 can perform some or all of the blocks described as being performed by the device 132.

At block 205, the device 132 can be configured to initiate capture of a sequence of images, e.g., in the form of a video stream. At block 210, the device 132 is configured to receive a scan command, e.g., via the input device 156. The scan command can include the depression of a hardware button or trigger, the selection of a soft button presented on the display 160, or the like. In general, the scan command is an instruction to capture and decode a barcode within a current field of view of the camera 158. In response to the scan command, therefore, at block 215, the device 132 is configured to capture and decode a machine readable indicium, such as a barcode, within the field of view of the camera 158.

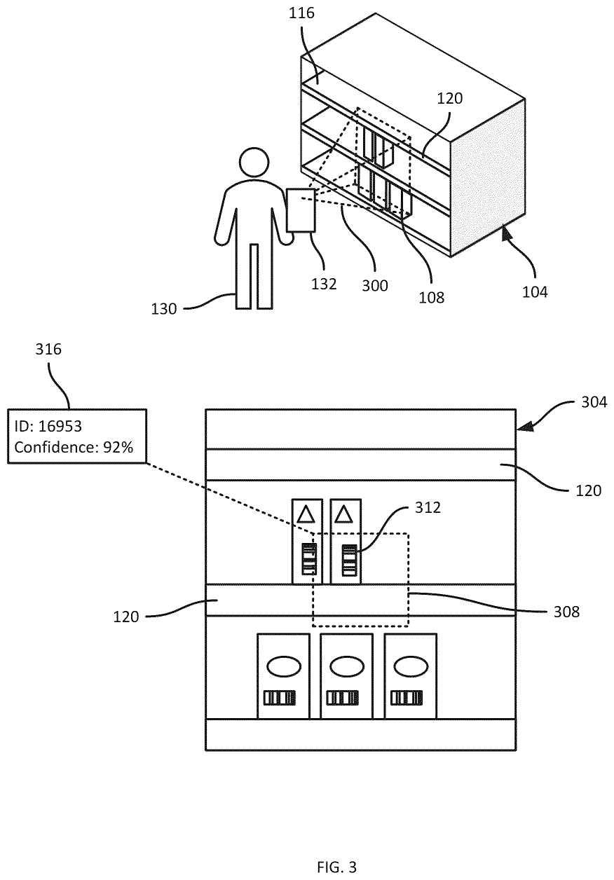

As noted earlier, capture of a barcode can be implemented by extracting a predefined portion of an image, such as the most recent frame of the sequence initiated at block 205. For example, turning to FIG. 3, the scan command is received with a field of view 300 of the camera 158 directed at a portion of a shelf module 104. The device 132 is configured to retrieve the most recently captured image 304 from the above-mentioned sequence. At block 215, the device 132 is configured, in this example, to extract a portion 308 of the image 304, and to process the extracted portion 308 to detect a barcode 312 therein. As will be apparent, the device 132 can render an aiming aid on the display 160, e.g., indicating the extent of the portion 308 overlaid on the image 304. In other examples, the aiming aid can include a distinct light emitter, such as a laser pointer.

As shown in FIG. 3, the device 132 is configured to locate the barcode 312 within the portion 308, and process the barcode 312 to generate data 316 including an item identifier “16953”, as well as a scan confidence level (92%, in this example; a wide variety of other forms of confidence level can also be employed instead of a percentage as illustrated). The scan confidence level indicates a likelihood that the item identifier is the correct string encoded in the barcode 312 (i.e., that the barcode 312 was correctly decoded).

Returning to FIG. 2, substantially simultaneously with block 215, the device 132 is configured to detect one or more items in the image 304. For example, the device 132 can be configured, as noted earlier, to process the image 304 via a suitable image segmentation and object recognition algorithm, such as Mask R-CNN or the like. Detection of items can include, for example, providing the image 304 to a classifier, executed at the device 132 itself (e.g., as a component of the application 168) or at the server 128. The classifier can return a set of bounding boxes and item identifiers, as well as classification confidence levels associated with each item identifier. The classification confidence levels, as will be apparent, indicate a likelihood that the item identifiers derived for each bounding box are correct.

In other examples, the performance of block 220 can include detecting the above-mentioned bounding boxes, e.g., via edge detection or other suitable segmentation algorithms, and then extracting image features from each bounding box and providing such image features to a classifier. Some classifiers, such as Mask R-CNN, perform both segmentation and feature extraction, using the entire image 304 as an input. Other classifiers can instead be configured to classify sets of features for each bounding box, with the bounding boxes and feature sets being extracted by separate algorithms.

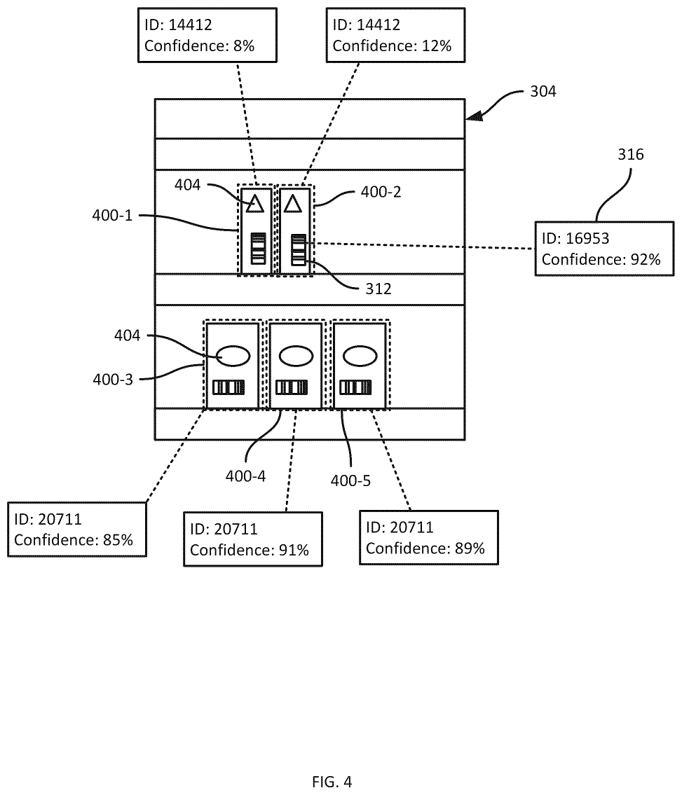

Any of a wide variety of image features can be employed at block 220, including edges, shapes, colors, text strings (e.g., detected via optical character recognition (OCR)), symbols (e.g., detected via optical mark recognition (OMR)) keypoints (e.g., detected via a suitable keypoint detector such as Oriented FAST, Rotated BRIEF (ORB)), and the like. For example, turning to FIG. 4, five bounding boxes 400-1, 400-2, 400-3, 400-4, and 400-5 are illustrated as resulting from a performance of block 220. When the camera 158 captures depth data (e.g., when the camera 158 includes a time-of-flight sensor, or the like), image features as mentioned above can also include features derived from depth measurements.

In addition to the bounding boxes (e.g., expressed in pixel coordinates, or according to the coordinate system 136 if the pose of the device 132 is tracked), the device 132 obtains classified item identifiers (e.g., 14412, and 20711) and confidence levels for each bounding box 400. The item identifiers can be obtained using various image features extracted from the bounding boxes, such as features associated with graphics 404 appearing on the items 108.

As will be apparent from FIG. 4, the item identifier detected from the image 304 at block 220 for the bounding box 400-2 does not match the item identifier decoded from the barcode 312. In addition, the confidence levels associated with the bounding boxes 400-1 and 400-2 indicate a low likelihood that the item identifiers “14412” are correct for those items 108. For example, the packaging of the corresponding items may have changed recently, with the result that the classification algorithm is no longer able to effectively identify that item type.

Having captured the barcode and detected items in the image 304, the device 132 is then configured to assess the above-mentioned confidence levels and, based on that assessment, select one or more item identifiers for use in generating output data, such as item status data, notifications, and the like.

In particular, returning to FIG. 2, at block 225 the device 132 is configured to determine whether the scan confidence level from block 215 exceeds a configurable threshold (e.g., 70%, although a wide variety of other thresholds can also be employed). When the determination at block 225 is affirmative, as in the example shown in FIGS. 3 and 4, the device 132 proceeds to block 230.

At block 230, the device 132 is configured to determine whether the classification confidence level is above a threshold. The threshold employed at block 230 can be, but is not necessarily, the same as the threshold employed at block 225. In this example, the threshold at block 230 is 60%. The device 132 is therefore configured to determine whether the classification confidence level associated with the item detection from block 220 that corresponds to the detected barcode 312 is above 60%. The device 132 can associate the barcode 312 with a detected item from block 220 by, for example, determining which bounding box 400 contains the barcode 312. In this example, therefore, the device 132 is configured to determine, at block 230, whether the classification confidence level associated with the bounding box 400-2 (i.e., 12%) exceeds the above-mentioned threshold.

In this example, as will be apparent, the determination at block 230 is negative. A negative determination at block 230 may indicate that the visual features of the relevant item 108 have changed since the classifier employed at block 220 was trained. The negative determination at block 230 may also indicate that the relevant item 108 is simply new to the facility 100, and that the classifier employed at block 220 has not been trained to recognize that item 108.

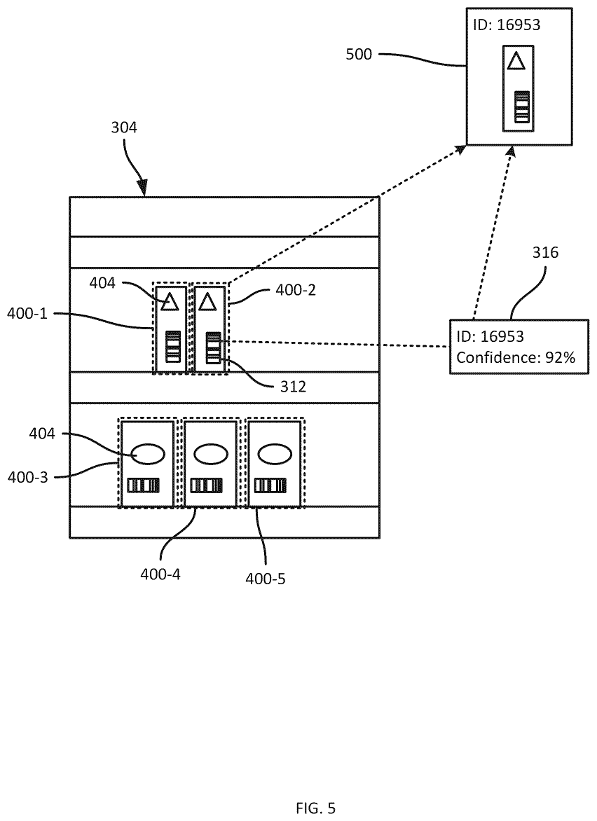

Following a negative determination at block 230, the device 132 proceeds to block 235. At block 235, the device 132 generates a training sample for the corresponding item 108. Specifically, although the image recognition process from block 220 did not successfully identify the item 108, the barcode capture process of block 215 did (as indicated by the positive determination at block 225). The decoded item identifier from block 215 can therefore be employed as a label for the training data sample, The training data sample can also include a portion of the image, e.g., within the bounding box 400-2, and/or a set of features extracted from the bounding box 400-2. Turning to FIG. 5, an example training data sample 500 is illustrated, including the item identifier “16953” obtained at block 215, and image data from the bounding box 400-2 (but not the item identifier derived from that image data).

Returning to FIG. 2, at block 240, following block 235 or following an affirmative determination at block 230, the device 132 is configured to select the decoded item identifier (i.e., from block 215) for further processing according to the current workflow, and to then proceed to block 245. At block 245, the device 132 is configured to generate and/or send output data, such as the above-mentioned training data sample, item status data, notifications containing the item status data, and the like.

The output data at block 245 can include, in some examples, a count of one or more items detected in the image 304. For example, the output data can include the item identifier “20711” and a count of three, indicating that three instances of the corresponding item were detected in the image 304. The output data can also include a count associated with the item identifier “16953”, despite the fact that the image recognition process at block 220 did not successfully identify the items in the bounding boxes 400-1 and 400-2. The capture and decoding of the barcode 312, and the association of the barcode 312 with the bounding box 400-2, enables the device 132 to assign an item identifier to the bounding box 400-2. Further, by matching features between the bounding boxes 400-1 and 400-2, the device 132 can also assign the same item identifier to the bounding box 400-1.

A wide variety of other output data is also contemplated. For example, the output data can include a request to the server 128 for a price or other attribute associated with the decoded item identifier. The output data can also include a notification, e.g., to the server 128, that an item has been picked (as identified by the decoded item identifier selected at block 240), the results of a comparison between the item identifier at block 240 and a delivery manifest, or the like.

Returning to FIG. 2, when the determination at block 225 is negative, indicating that the barcode decoding process at block 215 did not yield a sufficient confidence level, at block 250 the device 132 can determine whether the classification confidence level exceed the relevant threshold. When the determination at block 250 is negative, the device 132 can present a prompt to repeat the barcode scan (i.e., to return to block 210) via the display 160. If the determinations at both blocks 225 and 250 are negative, the image 304 may contain artifacts interfering with processing.

When the determination at block 250 is affirmative, however, the device 132 can proceed to block 260, and select the classified item identifier for further processing rather than the decoded item identifier. That is, despite the barcode decoding process having failed to produce a reliable result, the device 132 can proceed with the relevant workflow, using the results of the image recognition process of block 220 in place of the decoding results. Following selection of the classified item identifier at block 260, the device 132 can proceed to block 245, as described above (e.g., to generate item counts, compare the selected item identifier to an expected item identifier, or the like).

Following the generation of output data at block 245, such as the status data and/or notifications mentioned above, the device 132, or the server 128, can continue to generate further status data and/or notifications, based on additional images captured by the camera 158 or other cameras within the facility. In particular, such monitoring of item status can be performed with fewer, or no, additional barcode scans being necessary. The device 132 and/or server 128 can, however, continue to monitor classification confidence and, optionally, other criteria in order to prompt for additional barcode scans under some conditions.

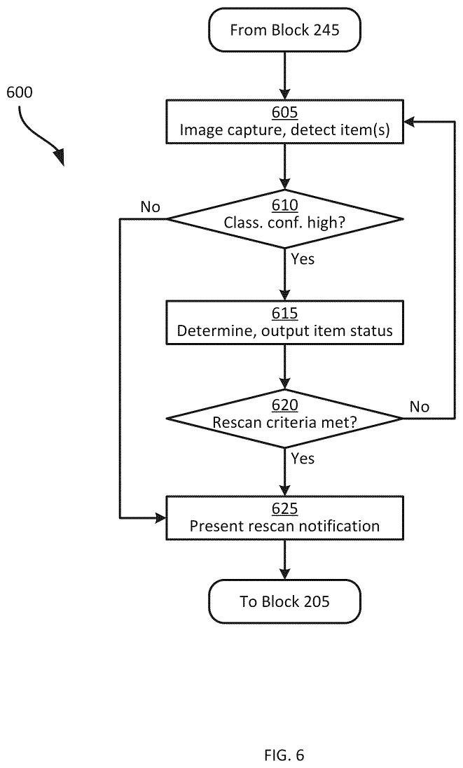

Specifically, FIG. 6 illustrates a method 600 of item status monitoring, e.g., performed following the method 200. At block 605, the device 132 and/or server 128 can obtain additional images, e.g., from the camera 158 or other cameras in the facility, e.g., in the form of one or more video streams or other periodic capture processes. The device 132 and/or server 128 is configured to identify items in the image(s), as described above in connection with block 220 (that is, via a classifier or other suitable item detection mechanism). As noted earlier, item detections include item identifiers and classification confidence levels.

At block 610, the device 132 and/or server 128 is configured to determine whether the classification confidence level from block 605 exceeds a threshold, as discussed in connection with block 230. When the determination at block 610 is affirmative, indicating that the item has been detected with sufficiently high confidence from the image, the device 132 and/or server 128 can proceed to block 615. At block 615, the device 132 and/or server 128 is configured to determine and store or otherwise output item status data, such as an item location in the facility, an item count, or the like. Other examples of such status data are discussed earlier in connection with block 245.

Following block 615, the device 132 and/or server 128 can determine, at block 620, whether rescan criteria have been met, e.g., irrespective of the sufficient classification confidence assessed at block 610. Example rescan criteria include movement of the relevant item (e.g., when item location is generated at block 615) at a greater speed than a predetermined threshold, and/or into or out of a predetermined area of the facility where detection of the item is not typically expected. Other rescan criteria include, in examples where the location of a specific instance of an item is being tracked over time, the loss of tracking for a threshold time (e.g., losing visibility and/or location of the item for a predetermined time period, such as several seconds or longer).

When the determination at block 620 is negative, the device 132 and/or server 128 returns to block 605 (e.g., without requiring further barcode scans). When the determination at block 620 is affirmative, or when the determination at block 610 is negative (indicating insufficient confidence in the image-based item detection), the device 132 and/or server 128 can generate a prompt to perform another barcode scan (e.g., as described in connection with block 255) of the relevant item, by returning to block 205.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
responsive to a scan command, controlling a sensor assembly to scan a machine-readable indicium within a sensor field of view;
obtaining an image corresponding to the sensor field of view;
determining, from the machine-readable indicium, a decoded item identifier and a scan confidence level associated with the decoded item identifier;
determining, from the image, a classified item identifier corresponding to the machine-readable indicium, and a classification confidence level associated with the classified item identifier;
selecting, based on the scan confidence level and the classification confidence level, one of the decoded item identifier and the classified item identifier; and
generating output data based on the selected one of the decoded item identifier and the classified item identifier.

2. The method of claim 1, wherein the sensor assembly includes a barcode scanner configured to scan the machine-readable indicium, and a camera configured to capture the image.

3. The method of claim 1, wherein the sensor assembly includes a camera; and wherein controlling the sensor assembly to scan the barcode includes:
capturing the image; and
extracting a portion of the image.

4. The method of claim 1, wherein the selecting includes:
determining that (i) the scan confidence level exceeds a first threshold, and that (ii) the classification confidence level does not exceed a second threshold; and
selecting the decoded item identifier.

5. The method of claim 4, wherein determining the classified item identifier includes:
detecting an item bounding box that contains the barcode;
deriving image features from within the bounding box; and
providing the image features to a classifier.

6. The method of claim 5, wherein the output data includes a classification training data sample including the decoded item identifier, and the image features.

7. The method of claim 5, further comprising:
detecting, from the image, an additional item bounding box that does not contain the barcode;
deriving additional image features from the additional bounding box;
determining that the additional image features match the image features;
associating the decoded item identifier with the additional item bounding box;
wherein the output data includes a count of items associated with the decoded item identifier.

8. The method of claim 1, wherein the selecting includes:
determining that (i) the scan confidence level does not exceed a first threshold, and that (ii) the classification confidence level exceeds a second threshold; and
selecting the classified item identifier.

9. The method of claim 1, wherein generating the output data includes comparing the selected one of the decoded item identifier and the classified item identifier to an expected item identifier; and
generating a notification when the selected item identifier does not match the expected item identifier.

10. The method of claim 1, further comprising:
obtaining a further image;
determining, from the further image, a further classified item identifier corresponding to the machine-readable indicium, and a further classification confidence level associated with the further classified item identifier;
determining whether a rescan criterion is satisfied; and
when the rescan criterion is satisfied, generating a prompt to obtain a further scan of the machine-readable indicium.

11. The method of claim 10, wherein the rescan criterion includes at least one of: an item location corresponding to a predetermined area; an item movement speed exceeding a threshold; and a period of time during which an item bearing the machine-readable indicium is occluded from the sensor field of view exceeding a threshold.

12. A computing device, comprising:
a sensor assembly; and
a processor configured to:
responsive to a scan command, control the sensor assembly to scan a machine-readable indicium within a sensor field of view;
obtain an image corresponding to the sensor field of view;
determine, from the machine-readable indicium, a decoded item identifier and a scan confidence level associated with the decoded item identifier;
determine, from the image, a classified item identifier corresponding to the machine-readable indicium, and a classification confidence level associated with the classified item identifier;
select, based on the scan confidence level and the classification confidence level, one of the decoded item identifier and the classified item identifier; and
generate output data based on the selected one of the decoded item identifier and the classified item identifier.

13. The computing device of claim 12, wherein the processor is further configured to:
obtain a further image;
determine, from the further image, a further classified item identifier corresponding to the machine-readable indicium, and a further classification confidence level associated with the further classified item identifier;
determine whether a rescan criterion is satisfied; and
when the rescan criterion is satisfied, generating a prompt to obtain a further scan of the machine-readable indicium.

14. The computing device of claim 13, wherein the rescan criterion includes at least one of: an item location corresponding to a predetermined area; an item movement speed exceeding a threshold; and a period of time during which an item bearing the machine-readable indicium is occluded from the sensor field of view exceeding a threshold.

15. The computing device of claim 12, wherein the processor is configured to select one of the decoded item identifier and the classified item identifier by:
determining that (i) the scan confidence level exceeds a first threshold, and that (ii) the classification confidence level does not exceed a second threshold; and
selecting the decoded item identifier.

15. The computing device of claim 14, wherein the processor is configured to determine the classified item identifier by:
detecting an item bounding box that contains the barcode;
deriving image features from within the bounding box; and
providing the image features to a classifier.

16. The computing device of claim 15, wherein the output data includes a classification training data sample including the decoded item identifier, and the image features.

17. The computing device of claim 15, wherein the processor is further configured to:
detect, from the image, an additional item bounding box that does not contain the barcode;
derive additional image features from the additional bounding box;
determine that the additional image features match the image features;
associate the decoded item identifier with the additional item bounding box;
wherein the output data includes a count of items associated with the decoded item identifier.

18. The computing device of claim 11, wherein the processor is configured to select one of the decoded item identifier and the classified item identifier by:
determining that (i) the scan confidence level does not exceed a first threshold, and that (ii) the classification confidence level exceeds a second threshold; and
selecting the classified item identifier.

19. The computing device of claim 11, wherein the processor is configured to generate the output data by comparing the selected one of the decoded item identifier and the classified item identifier to an expected item identifier; and
generating a notification when the selected item identifier does not match the expected item identifier.

20. A method, comprising:
responsive to a scan command, controlling a sensor assembly to scan a machine-readable indicium within a sensor field of view;
obtaining an image corresponding to the sensor field of view;
determining, from the machine-readable indicium, a decoded item identifier;
determining, from the image, a classified item identifier corresponding to the machine-readable indicium, and a classification confidence level associated with the classified item identifier;
selecting, based on the classification confidence level, one of the decoded item identifier and the classified item identifier; and
generating output data based on the selected one of the decoded item identifier and the classified item identifier.

21. The method of claim 20, further comprising:
determining whether a rescan criterion is satisfied; and
when the rescan criterion is satisfied, generating a prompt to obtain a further scan of the machine-readable indicium.

22. The method of claim 20, wherein the rescan criterion includes a location criterion includes at least one of: an item location corresponding to a predetermined area; an item movement speed exceeding a threshold; and a period of time during which an item bearing the machine-readable indicium is occluded from the sensor field of view exceeding a threshold.
